(19) United States
(12) Patent Application Publication
(10) Pub. No.: US 2022/0010870 A1
(43) Pub. Date: Jan. 13, 2022

(54) INTEGRATED TAPPET ASSEMBLY

(71) Applicant: Cummins Inc., Columbus, IN (US)

(72) Inventors: Steven Valentin, Columbus, IN (US); Ross A. Phillips, Columbus, IN (US); Romaine O. Edwards, Greenwood, IN (US); Eric A. Benham, Columbus, IN (US); Marian Trocki, Columbus, IN (US); Richard E. Duncan, Greenwood, IN (US); Neil Jeffries, Indianapolis, IN (US); Karthik Sethuraman, Columbus, IN (US)

(21) Appl. No.: 17/293,599

(22) PCT Filed: Feb. 12, 2019
(86) PCT No.: PCT/US19/17604

§ 371 Date: May 13, 2021

(51) Int. Cl. F16H 53/06; F02M 59/44; F01L 1/14; F02M 59/10

(52) U.S. Cl. CPC F16H 53/06; F02M 59/102; F01L 1/14; F02M 59/44

(57) ABSTRACT

A tappet assembly (100) used in mechanical equipment includes a tappet body (108) having a cylindrical shape and including a lower carrier portion (152) and an upper shell portion (158) having a cavity (150) defined by an inner wall (160) of the upper shell portion (158) and a top surface (154) of the lower carrier portion (152). The lower carrier portion (152) and the upper shell portion (158) are integrally formed as a single-piece unit. A post (162) extends upwardly from the top surface (154) of the lower carrier portion (152) and is configured to reduce a peak contact pressure associated with the tappet body (108).

### CROSS-REFERENCE TO RELATED APPLICATIONS

None.

### TECHNICAL FIELD OF THE DISCLOSURE

The present disclosure relates generally to a tappet assembly, and more specifically to an integrated tappet assembly having a single-piece body.

### BACKGROUND OF THE DISCLOSURE

Typically, tappets are used as a mechanism for facilitating the lifting of valves in a valvetrain of an engine and pumping fuel in a fuel pump. An existing tappet assembly includes an outer shell having a cavity configured to receive a carrier for a roller such that the carrier is press-fitted in the cavity. During operation, due to unwanted movement of the carrier in the shell, the perpendicularity of the tappet assembly can be compromised. For example, since the shell and carrier are separately installed in the tappet assembly, the unwanted movement of the carrier can cause a tilted alignment of the tappet assembly. Such positional errors of the tappet assembly also cause shell and/or carrier distortions over a prolonged period of time. Further, the positional errors related to a lubricant feed bore in the shell can lead to a reduced lubricant flow area in the tappet assembly. For example, the lubricant feed bore can be blocked due to debris generated by the positional errors. Another problem of the separately installed shell and carrier is that the unwanted movement of the carrier increases a contact pressure in the tappet assembly due to a contact stress generated by the unwanted movement of the carrier and the roller.

As such, it is desirable to reduce or eliminate the positional errors and the contact pressure of the tappet assembly. Accordingly, there are opportunities to develop an enhanced tappet assembly that can more efficiently perform the lifting of the valves.

### SUMMARY OF THE DISCLOSURE

In one embodiment of the present disclosure, a tappet assembly used in mechanical equipment is provided. Included in the tappet assembly is a tappet body having a cylindrical shape and including a lower carrier portion and an upper shell portion having a cavity defined by an inner wall of the upper shell portion and a top surface of the lower carrier portion. The lower carrier portion and the upper shell portion are integrally formed as a single-piece unit. A post extends upwardly from the top surface of the lower carrier portion and is configured to reduce a peak contact pressure associated with the tappet body.

In one example, the lower carrier portion has a substantially solid body.

In another example, the post is positioned substantially at a center of the top surface of the lower carrier portion.

In yet another example, the post is a cylindrical column.

In still another example, a lubricant feed groove is disposed on an outer wall of the tappet body and is configured to receive a lubricant. In a variation, the lubricant is an oil or a fuel. In another variation, the lubricant feed groove continuously extends between the upper shell portion and the lower carrier portion. In yet another variation, the lubricant feed groove includes a feed hole configured to deliver the lubricant to the tappet assembly.

In yet still another example, at least one air vent is disposed in the lower carrier portion of the tappet body for facilitating an escape of a compressed air in the cavity.

In another embodiment of the present disclosure, a tappet assembly used in mechanical equipment is provided. The tappet assembly includes a tappet body including a lower carrier portion having an opening formed on a bottom surface of the lower carrier portion, and an upper shell portion having a cavity defined by an inner wall of the upper shell portion and a top surface of the lower carrier portion. The lower carrier portion and the upper shell portion are integrally formed as a single-piece unit. Further, the tappet assembly includes a roller having a substantially cylindrical shape and a longitudinal length less than an outer diameter of the tappet body wherein the roller is configured to be inserted into the opening of the lower carrier portion, and a ring configured to restrict movement of the roller.

In one example, the lower carrier portion of the tappet body includes an indented radial seating surface. In a variation, the ring is configured to at least partially encircle an outer surface of the indented radial seating surface. In another variation, the ring is pressed-fit onto the outer surface of the indented radial seating surface. In yet another variation, a radially extending rib is formed on the outer surface of the indented radial seating surface and configured to restrict movement of the ring.

In another example, both opposite longitudinal ends of the roller are encircled by an inner surface of the ring.

In yet another example, the ring is configured to align the roller horizontally in the opening transverse to a longitudinal axis of the tappet body.

In still another example, a slot is disposed in the upper shell portion of the tappet body. In a variation, the slot is configured to receive a pin for supporting the tappet assembly. In another variation, the slot is an elongated opening configured to accommodate an insertion of the pin.

In yet still another variation, a passage way is disposed in the lower carrier portion and configured to deliver a lubricant to the roller.

While multiple embodiments are disclosed, still other embodiments of the presently disclosed subject matter will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

The features of this disclosure and the manner of obtaining them will become more apparent and the disclosure itself will be better understood by reference to the following description of embodiments of the present disclosure taken in conjunction with the accompanying drawings, wherein:

FIG. 1 is a perspective view of a fuel pump for use with a tappet assembly in accordance with embodiments of the present disclosure;

FIG. 2 is a front perspective view of the fuel pump of FIG. 1 with a cut-away portion illustrating a portion of the tappet assembly of FIG. 1;

FIG. 3 is a perspective view of a tappet assembly in accordance with embodiments of the present disclosure;

FIG. 4 is another perspective view of the tappet assembly of FIG. 3;

FIG. 5 is a cross-sectional view of the tappet assembly of FIG. 3;

FIG. 6 is an exploded view of the tappet assembly of FIG. 3;

FIG. 7 is a side view of the tappet assembly of FIG. 3;

FIG. 8 is another side view of the tappet assembly of FIG. 3;

FIG. 9 is a cross-sectional view of the tappet assembly of FIG. 7;

FIG. 10 is a cross-sectional view of the tappet assembly of FIG. 8; and

FIG. 11 is a further cross-sectional view of the tappet assembly of FIG. 3.

While embodiments of the present disclosure are amenable to various modifications and alternative forms, specific embodiments have been shown by way of example in the drawings and are described in detail below. The intention, however, is not to limit the particular embodiments described herein. On the contrary, the disclosure is intended to cover all modifications, equivalents, and alternatives falling within the scope of the disclosure as defined by the appended claims.

### DETAILED DESCRIPTION OF THE DRAWINGS

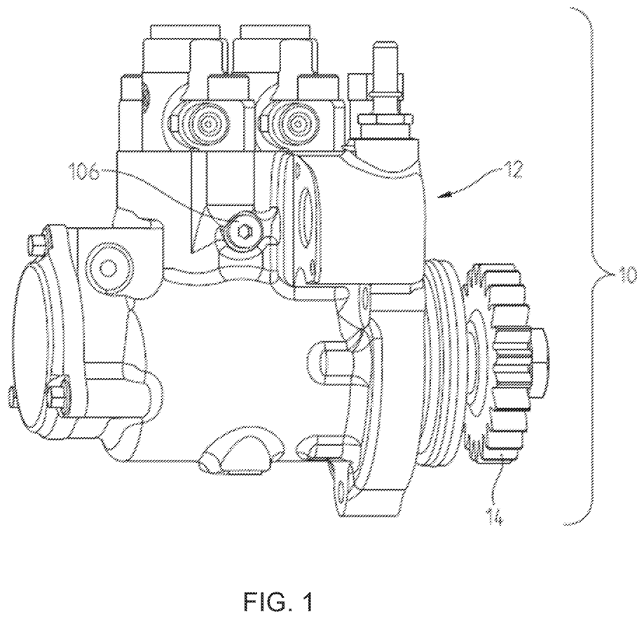

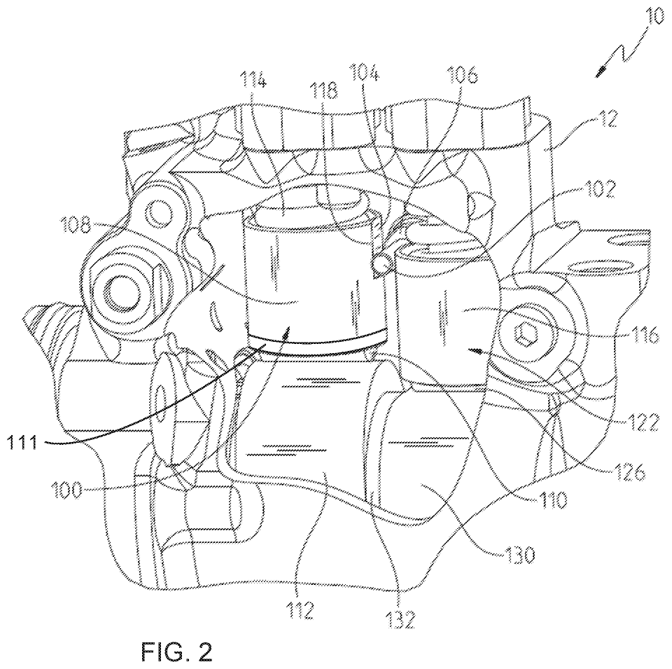

Referring now to FIGS. 1-2, a fuel pump 10 configured for use with an engine (not shown) is shown. Fuel pump 10 can include an outer housing 12 and at least one engagement member 14, illustratively a gear, configured to engage with a portion of the engine. For example, engagement member 14 may be configured to engage or mesh with a gear driven by the crankshaft (not shown) of the engine for providing rotational or other movement to fuel pump 10 to pump fuel therein to the engine.

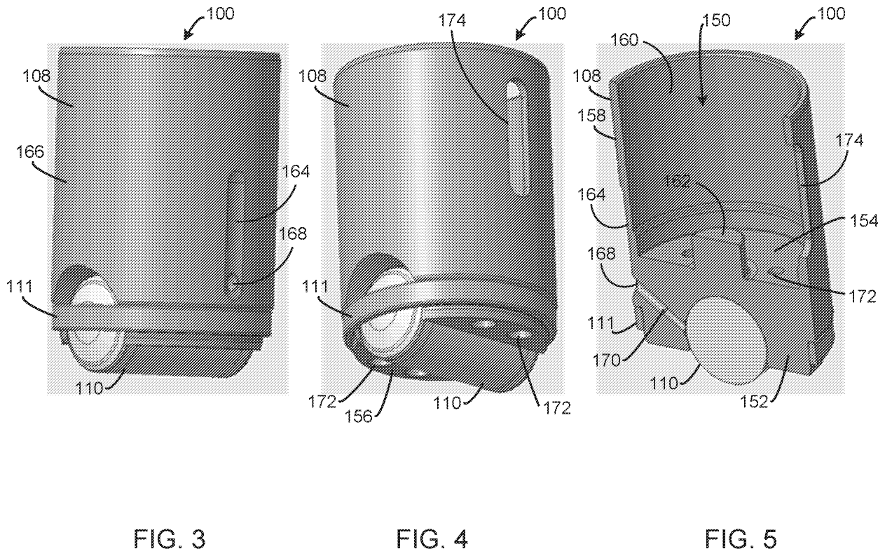

In one embodiment, fuel pump 10 includes a tappet assembly 100 (FIG. 3) which is positioned within a portion of outer housing 12 of fuel pump 10. Tappet assembly 100 of fuel pump 10 includes a tappet body 108, a roller 110, and a ring 111. Illustratively, fuel pump 10 also may include a second tappet 122 which includes a tappet body 116 and a roller 126. In some embodiments, a lock bar or protrusion 102, affixed to a mount 106 which is coupled to a portion of the engine or fuel pump 10, is positioned in close proximity to a flat portion 104 of the tappet assembly 100.

An exemplary lock bar 102 and related components are described and illustrated in International Application No. PCT/US2016/025150 (International Publication No. WO 2016/175975 A1), filed Mar. 31, 2016, titled “PINLESS TAPPET IN A COMMON RAIL HIGH PRESSURE FUEL PUMP,” which is hereby incorporated herein by reference in its entirety for all that it teaches and for all purposes.

Referring now to FIGS. 3-5, tappet assembly 100 is configured to impart linear motion to various components of a vehicle. For example, tappet assembly 100 can be used in mechanical equipment, such as engines or related accessories of the vehicle for imparting linear motion to a pushrod based on rotational motion from a camshaft. In another example, tappet assembly 100 can also be used in fluid power systems, valve systems, fuel systems, and hydraulic pump applications. Tappet assembly 100 can also be used with a fuel pump and/or a valvetrain for an engine.

In one embodiment, tappet assembly 100 includes tappet body 108, roller 110, and ring 111. Tappet body 108 has a substantially cylindrical shape and includes a cavity 150 configured to receive a biasing member (not shown), such as a spring. Unlike a conventional tappet assembly having a tappet shell and a carrier pressed into the shell, tappet assembly 110 includes a shell and a carrier that are integrated together as a single unit (i.e., tappet body 108). For example, as shown in FIG. 5, tappet body 108 includes a lower carrier portion 152 having a top surface 154 and a bottom surface 156 (FIG. 4). Lower carrier portion 152 has a substantially solid body.

Further, tappet body 108 includes an upper shell portion 158 having cavity 150 defined by an inner wall 160 of upper shell portion 158 and top surface 154 of lower carrier portion 152. More specifically, upper shell portion 158 and lower carrier portion 152 of tappet body 108 are integrally formed as a single- or one-piece unit.

A post 162 extends upwardly from top surface 154 of lower carrier portion 152 and is configured to support the biasing member, such as a rod or other mechanical means of controlling valves or fuel pressures, and reduce a peak contact pressure associated with tappet body 108, e.g., between roller 110 and cavity 150 where roller 110 is inserted. Post 162 is positioned substantially at a center or near the center of top surface 154 of lower carrier portion 152. In one embodiment, post 162 is a cylindrical column, but other suitable protrusion, such as a dome, can be contemplated to suit different applications. In one embodiment, a height of post 162 can be approximately 5 millimeters and an outer diameter of post 162 can be approximately 9 millimeters, but other suitable dimensions are also contemplated to the suit different applications. In embodiment, post 162 is configured in such a way that contact pressures between roller 110 and tappet body 108 are reduced during operation.

As shown in FIGS. 1 and 3, a lubricant feed groove 164 is disposed on an outer wall 166 of tappet body 108 and is configured to receive a lubricant, such as an oil or a fuel. In one embodiment, one end of lubricant feed groove 164 begins at least partially at upper shell portion 158 of tappet body 108 and an opposite end of lubricant feed groove 164 ends at least partially at lower carrier portion 152 of tappet body 108. As such, lubricant feed groove 164 continuously extends between upper shell portion 158 and lower carrier portion 152. Lubricant feed groove 164 includes a feed hole 168 configured to deliver the lubricant to roller 110 through an optional passage way 170 (FIG. 5). In one example, the lubricant is delivered to feed groove 164 from an engine block of the vehicle. In various embodiments, a size, shape, or location of feed hole 168 can vary depending on a type of the lubricant. In some embodiments, lubricant feed groove 164 may not include feed hole 168.

As shown in FIGS. 4 and 5, one of more air vents 172 are disposed in lower carrier portion 152 of tappet body 108. In the illustrated embodiment, 4 air vents 172 are shown in lower carrier portion 152 of tappet body 108, but any number of air vents 172 can be used to suit different applications. In one embodiment, one end of each air vent 172 begins at top surface 154 of lower carrier portion 152 and an opposite end of each air vent 172 ends at bottom surface 156 of lower carrier portion 152. In this configuration, an air buildup compressed in cavity 150 during operation of tappet assembly 100 can be released via one or more air vents 172. Further, one or more air vents 172 are included to reduce tappet mass in tappet body 108.

In one embodiment, a slot 174 is disposed in upper shell portion 158 of tappet body 108 and is configured to receive a pin 182 (FIG. 10) for supporting tappet assembly 100 during operation. In one example, slot 174 has an elongated vertical opening configured to accommodate an insertion of the pin such that the pin is slidingly movable within the vertical opening to support linear movement of tappet assembly 100. In another example, pin 182 is mounted to a portion of the engine or fuel pump 10.

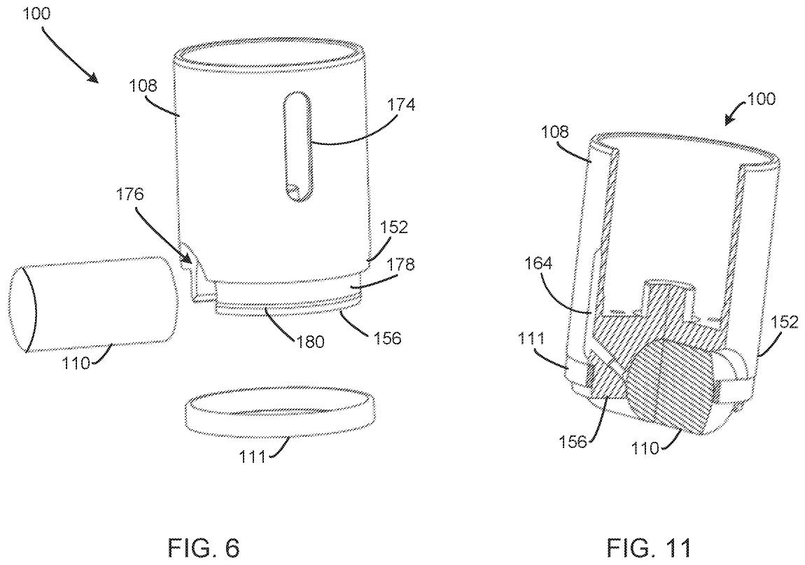

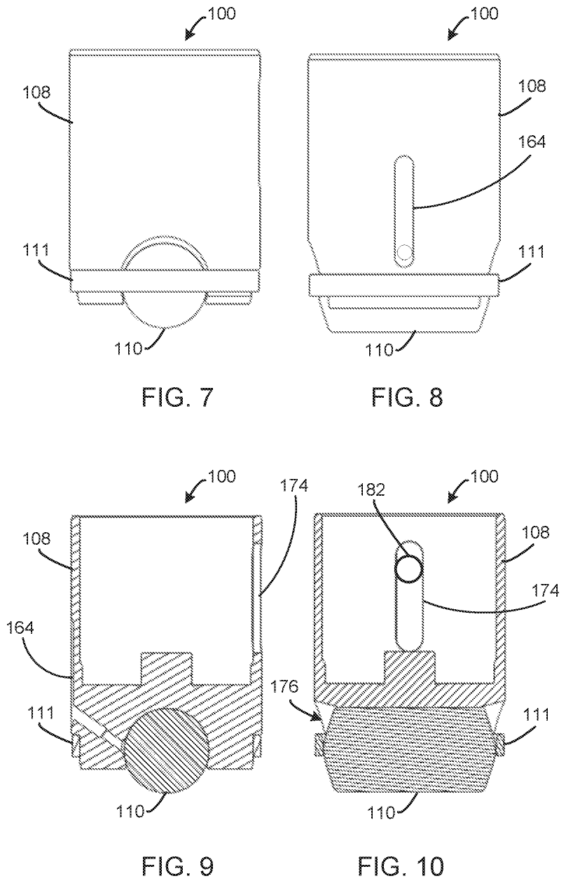

Referring now to FIGS. 6-11, roller 110 has a substantially cylindrical shape and has a longitudinal length less than an outer diameter of tappet body 108. In one embodiment, lower carrier portion 152 of tappet body 108 includes an opening 176 formed on bottom surface 156 of lower carrier portion 152. Opening 176 of lower carrier portion 152 is configured to receive and accommodate an insertion of roller 110 such that roller 110 is freely movable and/or axially rotatable within opening 176 during operation. However, translational movement along a longitudinal axis of roller 110 is limited or restricted by ring 111.

More specifically, lower carrier portion 152 of tappet body 108 includes an indented radial seating surface 178 at least partially encircling opening 176. In one embodiment, ring 111 can be a band that at least partially encircles an outer surface of indented seating surface 178. For example, ring 111 can be pressed-fit tightly onto the outer surface of indented seating surface 178 of lower carrier portion 152 of tappet body 108. A radially extending rib 180 is formed on the outer surface of indented seating surface 178 and is configured to limit or restrict movement of ring 111 during operation.

When assembled, both opposite longitudinal ends of roller 110 are encircled by an inner surface of ring 111. Thus, ring 111 is configured to align roller 110 horizontally in opening 176 transverse to a vertical longitudinal axis of tappet body 108 and also to restrict an axial movement of roller 110 inserted in opening 176 of lower carrier portion 152 during operation. No pin is used to restrict movement of roller 110.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

It also should be understood that usage herein of orientation-related terms such as “top,” “bottom,” “upper,” “lower,” “upward,” “downward,” “vertical,” and “horizontal” are used to assist in the explanation of the various embodiments of the present disclosure, and that it is envisioned that the embodiments described herein can be positioned and oriented in any number of ways. Similarly, terms such as “length” and “width” are also used for explanation purposes and their general usage does not, itself, imply that a length is necessarily larger than a width.

Additionally, it should be understood that the various embodiments contemplated herein can be used as in conjunction with (and can themselves be) engines and fuel pumps, although the embodiments of the present disclosure are not limited thereto.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A tappet assembly (100) used in mechanical equipment, comprising:
a tappet body (108) having a cylindrical shape and including a lower carrier portion (152) and an upper shell portion (158) having a cavity (150) defined by an inner wall (160) of the upper shell portion (158) and a top surface (154) of the lower carrier portion (152), the lower carrier portion (152) and the upper shell portion (158) being integrally formed as a single-piece unit; and
a post (162) extending upwardly from the top surface (154) of the lower carrier portion (152) and being configured to reduce a peak contact pressure associated with the tappet body (108).

2. The tappet assembly of claim 1, wherein the lower carrier portion (152) has a substantially solid body.

3. The tappet assembly of claim 1, wherein the post (162) is positioned substantially at a center of the top surface (154) of the lower carrier portion (152).

4. The tappet assembly of claim 1, wherein the post (162) is a cylindrical column.

5. The tappet assembly of claim 1, wherein a lubricant feed groove (164) is disposed on an outer wall (166) of the tappet body (108) and is configured to receive a lubricant.

6. The tappet assembly of claim 5, wherein the lubricant is an oil or a fuel.

7. The tappet assembly of claim 5, wherein the lubricant feed groove (164) continuously extends between the upper shell portion (158) and the lower carrier portion (152).

8. The tappet assembly of claim 5, wherein the lubricant feed groove (164) includes a feed hole (168) configured to deliver the lubricant to the tappet assembly (10).

9. The tappet assembly of claim 1, wherein at least one air vent (172) is disposed in the lower carrier portion (152) of the tappet body (108) for facilitating an escape of a compressed air in the cavity (150).

10. A tappet assembly (100) used in mechanical equipment, comprising:
a tappet body (108) including a lower carrier portion (152) having an opening (176) formed on a bottom surface (156) of the lower carrier portion (152), and an upper shell portion (158) having a cavity (150) defined by an inner wall (160) of the upper shell portion (158) and a top surface (154) of the lower carrier portion (152), the lower carrier portion (152) and the upper shell portion (158) being integrally formed as a single-piece unit;
a roller (110) having a substantially cylindrical shape and a longitudinal length less than an outer diameter of the tappet body (108), the roller (110) configured to be inserted into the opening (176) of the lower carrier portion (152); and
a ring (111) configured to restrict movement of the roller (110).

11. The tappet assembly of claim 10, wherein the lower carrier portion (152) of the tappet body (108) includes an indented radial seating surface (178).

12. The tappet assembly of claim 11, wherein the ring (111) is configured to at least partially encircle an outer surface of the indented radial seating surface (178).

13. The tappet assembly of claim 12, wherein the ring (111) is pressed-fit onto the outer surface of the indented radial seating surface (178).

14. The tappet assembly of claim 12, wherein a radially extending rib (180) is formed on the outer surface of the indented radial seating surface (178) and configured to restrict movement of the ring (111).

15. The tappet assembly of claim 10, wherein both opposite longitudinal ends of the roller (110) are encircled by an inner surface of the ring (111).

16. The tappet assembly of claim 10, wherein the ring (111) is configured to align the roller (110) horizontally in the opening (176) transverse to a longitudinal axis of the tappet body (108).

17. The tappet assembly of claim 10, wherein a slot (174) is disposed in the upper shell portion (158) of the tappet body (108).

18. The tappet assembly of claim 17, wherein the slot (174) is configured to receive a pin (182) for supporting the tappet assembly (10).

19. The tappet assembly of claim 17, wherein the slot (174) is an elongated opening configured to accommodate an insertion of the pin (182).

20. The tappet assembly of claim 10, wherein a passage way (170) is disposed in the lower carrier portion (152) and configured to deliver a lubricant to the roller (110).

21. The tappet assembly of claim 10, further comprising a post (162) extending upwardly from the top surface (154) of the lower carrier portion (152) and being configured to reduce a peak contact pressure associated with the tappet body (108)
